(19) United States
(12) Patent Application Publication
(10) Pub. No.: US 2012/0297210 A1
(43) Pub. Date: Nov. 22, 2012

(54) INTEGRATED CIRCUIT (IC) CARD SYSTEM

(75) Inventors: YUNBO YU, Shenzhen (CN); PINGXI MA, Shenzhen (CN); HONGJUN HUANGFU, Shenzhen (CN); QUAN GAN, Shenzhen (CN); SHAN ZHU, Shenzhen (CN)

(73) Assignee: NATIONZ TECHNOLOGIES INC., Shenzhen (CN)

(21) Appl. No.: 13/559,730

(22) Filed: Jul. 27, 2012

Related U.S. Application Data
(63) Continuation of application No. PCT/CN2010/071394, filed on Mar. 29, 2010.
Application No. PCT/CN2010/071394 is a continuation of application No. PCT/CN2010/073626, filed on Jun. 7, 2010.

(30) Foreign Application Priority Data
Jan. 27, 2010 (CN) 2010101016723
May 12, 2010 (CN) 201010169766.4

(51) Int. Cl. G06F 1/26

(52) U.S. Cl. 713/300

(57) ABSTRACT

An integrated circuit (IC) card is disclosed. The IC card includes a microprocessor and memory module configured to perform a transaction associated with the IC card, and an interface device providing a power input line from an external source. The IC card also includes a power management module coupled between the microprocessor and memory module and the interface device to convert power from the power input line into electric charge, to store the electric charge internally, and to provide power to the microprocessor and memory module when the external source does not provide sufficient power to the IC card.

### CROSS-REFERENCES TO RELATED APPLICATIONS

This application is a continuation application of PCT patent application no. PCT/CN2010/071394, filed on Mar. 29, 2010, which claims the priority of Chinese patent application no. 2010101016723, filed on Jan. 27, 2010, and PCT patent application no. PCT/CN2010/073626, filed on Jun. 7, 2010, which claims the priority of Chinese patent application no. 201010169766.4, filed on May 12, 2010, the entire contents of all of which are incorporated herein by reference.

### FIELD OF THE INVENTION

The present invention relates to the field of smart card technology and, more particularly, to power management techniques for integrated circuit (IC) cards.

### BACKGROUND

With the development of mobile communications technology, IC cards with radio frequency (RF) communication extensions, such as RF storage cards (e.g., RF SD cards) and RF smart cards (e.g., RF SIM cards), have been widely used. These extended functionalities often need a bigger power supply. For example, the value-added applications for RF SIM cards include mobile-terminal-based electronic purse, access control, public transportation, VIP card, etc. The implementation of these applications relies on increased number of components in the RF SIM card, and these applications also rely on the power supply in the mobile terminal.

However, when the power supply of a mobile phone is used for the IC cards, there may be some disadvantages. First, when the mobile phone is turned off, no power can be supplied to the RF SIM card to complete payment or credit card transactions. Second, because the RF SIM card has more components than a regular SIM card, the RF SIM card also has increased demand for working current. Some mobile phones cannot provide sufficient working current for the RF SIM card, especially when in standby mode.

The disclosed methods and systems are directed to solve one or more problems set forth above and other problems.

### BRIEF SUMMARY OF THE DISCLOSURE

One aspect of the present disclosure includes integrated circuit (IC) card. The IC card includes a microprocessor and memory module configured to perform a transaction associated with the IC card, and an interface device providing a power input line from an external source. The IC card also includes a power management module coupled between the microprocessor and memory module and the interface device to convert power from the power input line into electric charge, to store the electric charge internally, and to provide power to the microprocessor and memory module when the external source does not provide sufficient power to the IC card.

Another aspect of the present disclosure includes a storage card. The storage card includes a storage card module configured to provide storage functions associated with the storage card, and a charge storage module coupled to the storage card module. The charge storage module is configured to convert power from a power input line into electric charge, to store the electric charge internally, and to provide power to the storage card module when the external source does not provide sufficient power to the storage card.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary integrated circuit (IC) card consistent with the disclosed embodiments;

FIG. 2 illustrates a block diagram of an exemplary charge storage module consistent with the disclosed embodiments;

FIG. 3 illustrates a block diagram of another exemplary charge storage module consistent with the disclosed embodiments;

FIG. 4 illustrates a block diagram of another exemplary charge storage module consistent with the disclosed embodiments;

FIG. 5 illustrates an exemplary current limiting unit consistent with the disclosed embodiments;

FIG. 6 illustrates an exemplary energy storage unit consistent with the disclosed embodiments;

FIG. 7 illustrates an exemplary SIM card consistent with the disclosed embodiments;

FIG. 8 illustrates another exemplary SIM card consistent with the disclosed embodiments;

FIG. 9 illustrates an exemplary IC card system consistent with the disclosed embodiments;

FIG. 10 illustrates an exemplary power management module consistent with the disclosed embodiments;

FIG. 11 illustrates another exemplary power management module consistent with the disclosed embodiments;

FIG. 12 illustrates another exemplary power management module consistent with the disclosed embodiments; and

FIG. 13 illustrates an exemplary input current and output current diagrams of the IC card consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

FIG. 1 illustrates an exemplary integrated circuit (IC) card consistent with the disclosed embodiments. The IC card may include any appropriate type of IC card, such as an SD card, a SIM card, or any other smart card. The IC card may be incorporated into an external device, such as a mobile phone or a smart phone, or may be used as a stand-alone device.

As shown in FIG. 1, IC card 10 may be a SD card. SD card 10 may include an SD card module 101, a charge storage module or micro-battery 102, and an RF module 103. Other components may also be included.

The SD card module 101 may be used to implement functions of an ordinary SD card. The charge storage module or micro-battery 102 may provide power for the SD card 10. Further, the RF module 103 may be used to implement RF communication functions, such as the RF communication for electronic payment and access control, etc. In general, an SD card with an RF module may be referred as an RF SD card. Thus, the SD card 10 is an RF SD card. The SD card module 101 and the RF module 103 may be referred as an RF SD card module. In certain embodiments, the RF module 103 may be omitted. That is, the SD card 10 may include an ordinary SD card with the charge storage module or micro-battery 102.

A micro-battery may include any appropriate miniature battery suitable for use in a smart card. When the charge storage module or micro-battery 102 is a micro-battery, the micro-battery 102 may be embedded into the SD card 10. More particularly, the substrate of the SD card 10 may be configured to have empty hole punching positions for accommodating the micro-battery 102. The micro-battery 102 can then be pushed into the substrate of the SD card 10. Each empty hole may have certain exposed metal wires pre-embedded in the substrate, and the number of the metal wires, the caliber of the metal wires, and the embedding positions may be determined based on the SD card module 101 and the micro-battery 102.

Thus, the SD card module 101 can be physically connected or coupled to the micro-battery 102, and the SD card 10 can use the self-supplied power source. The physical connections between the SD card module 101 and the micro-battery 102 can be achieved by various means, such as metal wire welding, conductive glue, and laser welding, etc.

Also, various configurations may be used to connect or couple the SD card module 101 and the micro-battery 102, such as an embedding configuration, a combining configuration, and an integrating configuration, etc. In the embedding configuration, a battery hole (a through hole or a non-through hole) is punched on the SD card 10, and the micro-battery 102 is embedded into the hole. The VCC pin (i.e., power output pin) and the GND pin (i.e., ground pin) of the micro-battery 102 are coupled to the SD card 10 via metal contacts.

In the combining configuration, the SD card module 101 and the micro-battery 102 are combined together through a buckle(s) or a slot. The combined SD card module 101 and micro-battery 102 may then form the SD card 10, and may further be adapted to the mobile phone slot. Further, in the integrating configuration, the micro-battery 102 is integrated in the SD card 10. The micro-battery 102 may be invisible from the outlook of the SD card 10. The connection between the micro-battery 102 and the SD card module 101 is realized internally in the SD card 10.

The substrate of the SD card 10 may be made any appropriate type of material, such as Polyvinylchlorid (PVC) or a combination of PVC and ABS (Acryloabs, acrylonitrile-butadiene styrene copolymer), etc.

During operation, using the mobile phone as an example, when the mobile phone is switched on and is able to provide sufficient working current to the SD card 10, the SD card 10 uses the power supplied by the mobile phone and the micro-battery 102 is charged. When the mobile phone is switched on but unable to provide sufficient power to the SD card 10, the SD card 10 uses the power supplied by both the mobile phone and the micro-battery 102, and the micro-battery may provide the additional power exceeding the power supplied by the mobile phone. Further, when the mobile phone is turned off or in a standby mode, the SD card 10 uses power supplied by the micro-battery.

Further, the charge storage module or micro-battery 102 may also be a charge storage module. Various structures may be used to implement the charge storage module 102. FIG. 2 shows a block diagram of an exemplary charge storage module 102. As shown in FIG. 2, the charge storage module 102 includes a charging management unit 122, an energy storage unit 132, and a power supply conversion unit 142. Other components may also be included.

The input of the charging management unit 122 is coupled to a power input line (not numbered), and the output of the charging management unit 122 is coupled to the input of the energy storage unit 132. One input of the power supply conversion unit 142 is coupled to the power input line, and another input of the power supply conversion unit 142 is coupled to the output of the energy storage unit 132. The output of the power supply conversion unit 142 is coupled to the power supply input line of the SD card 10.

The power management unit 122 is used to convert input current into electric charge stored in the energy storage unit 132. The energy storage unit 132 is used to store the electric charge, and the power supply conversion unit 142 is used to select between the power input line and the energy storage unit 132, or select both, to supply power to the SD card 10.

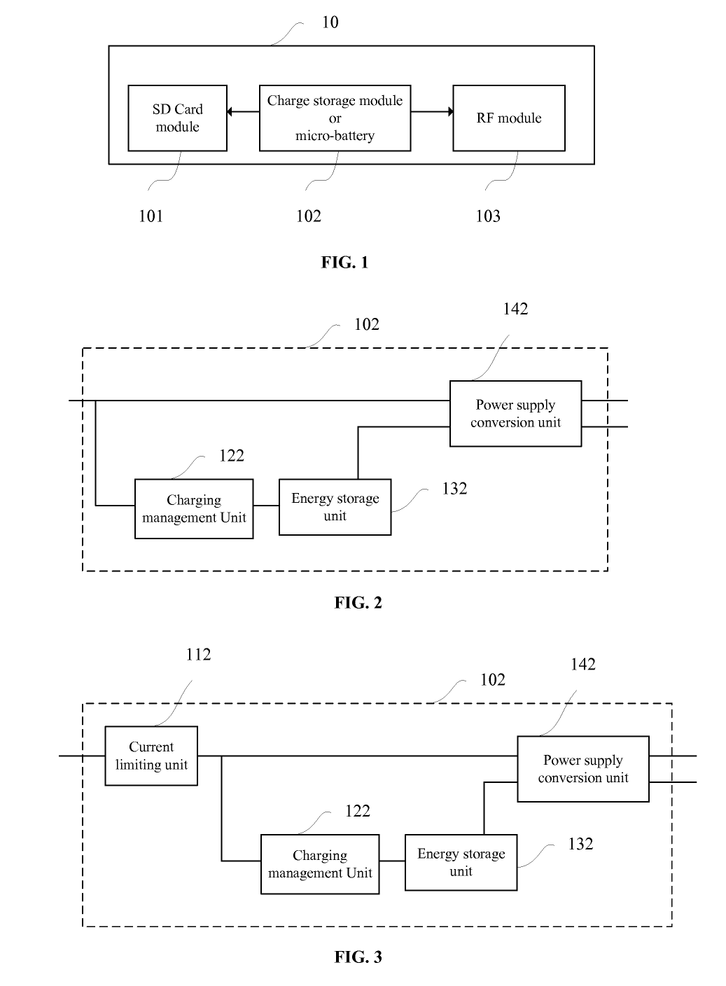

FIG. 3 shows a block diagram of another exemplary charge storage module 102. As shown in FIG. 3, the charge storage module 102 includes a current limiting unit 112, the charging management unit 122, the energy storage unit 132, and the power supply conversion unit 142. Other components may also be included.

The input of the current limiting unit 112 is coupled to a power input line (not numbered), and the output of the current limiting unit 112 is coupled to both the input of the charging management unit 122 and the first input of the power supply conversion unit 142. The input of the energy storage unit 132 is coupled to the output of the charging management unit 122, and the output of the energy storage unit 132 is coupled to the second input of the power supply conversion unit 142. The output of the power supply conversion unit 142 is coupled to the power supply input line of the SD card 10.

The current limiting unit 112 is configured to set a maximum pulse current based on a preset threshold. That is, pulse current with value greater than the preset threshold cannot pass through the current limiting unit 112. The power management unit 122 is used to convert input current into electric charge stored in the energy storage unit 132. The energy storage unit 132 is used to store the electric charge, and the power supply conversion unit 142 is used to select between the power input line (through the current limiting unit 112) and the energy storage unit 132, or select both, to supply power to the SD card 10.

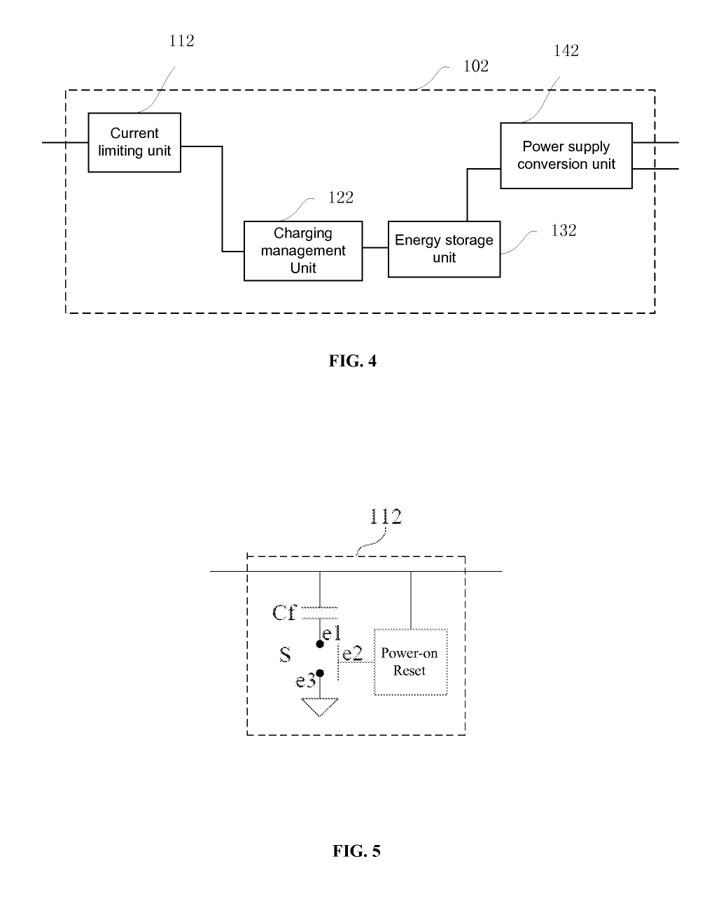

FIG. 4 shows a block diagram of another exemplary charge storage module 102. As shown in FIG. 4, the charge storage module 102 includes the current limiting unit 112, the charging management unit 122, the energy storage unit 132, and the power supply conversion unit 142, coupled in serial. The input of the current limiting unit 112 is coupled to a power input line (not numbered), and the output of the power supply conversion unit 142 is coupled to the power supply input line of the SD card 10.

FIG. 5 shows an exemplary current limiting unit 112. As shown in FIG. 5, the current limiting unit 112 includes a filter capacitor Cf, a switch S, and a power-on reset circuit. Other component(s) may also be included.

The filter capacitor Cf may include any appropriate capacitor for filtering pulse current. Switch S may include a terminal e1, a terminal e2, and a terminal e3, where the terminal e2 can connect or disconnect terminals e1 and e3. The power-on reset circuit may include any appropriate circuit capable of performing a reset function when the power is applied to the circuit.

Further, one end of the filter capacitor Cf is coupled to the power input line, and the other end of the filter capacitor Cf is coupled to the first terminal e1 of the switch S. The third terminal e3 is coupled to the ground, and the power-on reset circuit is coupled between the power input line and the second terminal e2 of the switch S. The second terminal e2 can be selectively connected to e1 and/or e3.

The filter capacitor Cf may be configured based on the preset threshold to limit a maximum pulse current (i.e., filter out). Further, in operation, after power-on, the power-on reset circuit may implement a time delay before slowly close the switch S, so as to avoid producing a large transient current by the filter capacitor Cf coupled between the power input line and the ground, which may cause power supply interruption due to overdrawn protection.

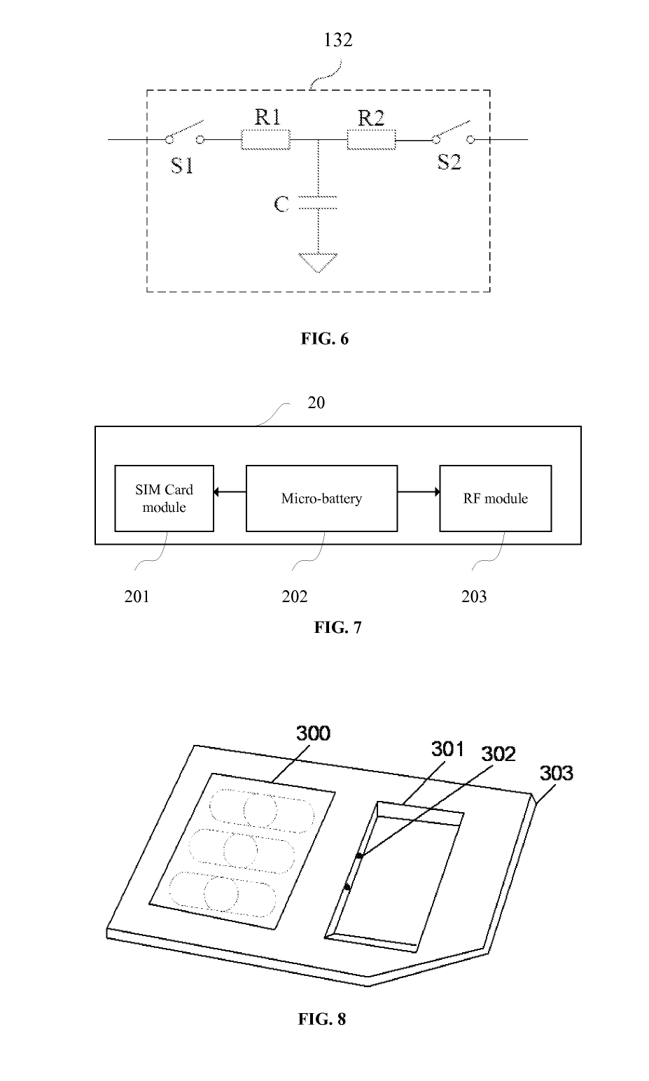

FIG. 6 shows an exemplary energy storage unit 132. As shown in FIG. 6, the energy storage unit 132 includes a charging switch S1, a charging current limiting resistor R1, a charging capacity C, a discharging resistor R2, and a discharging switch S2. Other components may also be included.

The charging switch S1, the charging current limiting resistor R1, the discharging resistor R2, and the discharging switch S2 are coupled in serial, while the charging capacitor C is coupled between the ground and the junction of the charging current limiting resistor R1 and discharging resistor R2.

In operation, when the electric charge in the charging capacitor C is lower than a charging threshold, the discharge switch S2 is disconnected and the charging switch S1 is closed such that the charging capacitor C is charged. After the charging is completed and/or the RF circuit, processor, memory circuit become operational and need more current, the charging switch S1 is disconnected and the discharging switch S2 is closed to supply electric charge or current to the power supply conversion unit 142.

In certain other embodiments, the SD card module 101 may be replaced with other storage card module, such as a TF card module or a multimedia card (MMC). The internal power management module may enable these storage card modules to have sufficient power supply even with extended functionalities.

In addition, other types of smart cards may also be adapted to the disclosed structures and functionalities. FIG. 7 shows an exemplary SIM card 20 consistent with the disclosed embodiments.

As shown in FIG. 7, SIM card 20 includes a SIM card module 201, a micro-battery 202, and an RF module 203. Other components may also be included. The SIM card module 201 may be used to implement functions of an ordinary SIM card. The micro-battery 202 may provide power for the SIM card 20. Further, the RF module 203 may be used to implement RF communication functions, such as the RF communication for electronic payment and access control, etc. Thus, the SIM card 20 is referred as an RF SIM card.

The SIM card module 201 and the RF module 203 may be referred as an RF SIM card module. In certain embodiments, the RF module 203 may be omitted. That is, the SIM card 20 may include an ordinary SIM card with the additional micro-battery 202.

Further, the substrate of the SIM card 20 may be configured to have empty hole punching positions for accommodating the micro-battery 202. The micro-battery 202 can then be pushed into the substrate of the SIM card 20. Each empty hole may have certain exposed metal wires pre-embedded in the substrate, and the number of the metal wires, the caliber of the metal wires, and the embedding positions may be determined based on the SIM card module 201 and the micro-battery 202.

That is, the SIM card module 201 can be physically connected or coupled to the micro-battery 202, and the SIM card 20 can use the self-supplied power source. The physical connections between the SIM card module 201 and the micro-battery 202 can be achieved by various means, such as metal wire welding, conductive glue, and laser welding, etc.

Similarly, various configurations may be used to connect or couple the SIM card module 201 and the micro-battery 202, such as an embedding configuration, a combining configuration, and an integrating configuration, etc. In the embedding configuration, a battery hole (through hole or non-through hole) is punched on the SIM card 20, and the micro-battery 202 is embedded into the hole. The VCC pin (i.e., power output pin) and the GND pin (i.e., ground pin) of the micro-battery 202 are coupled to the SIM card 20 through the metal contacts.

In the combining configuration, the SIM card module 201 and the micro-battery 202 are combined together through a buckle(s) or a slot. The combined SIM card module 201 and micro-battery 202 can then form the SIM card 20, and may be further adapted to a mobile phone slot. Further, in the integrating configuration, the micro-battery 202 is integrated in the SIM card 20. The micro-battery 202 may be invisible from the outlook of the SIM card 20. The connection between the micro-battery 202 and the SIM card module 201 is realized internally in the SIM card 20. The substrate of the SIM card 20 may be made of any appropriate type of material, such as PVC or a combination of PVC and ABS.

FIG. 8 shows an exemplary SIM card with micro-battery in the embedding configuration. As shown in FIG. 8, the substrate 303 for the SIM card contains both the SIM card module 300 and preserved battery hole or slot 301. Internal circuit is also preserved in the substrate 303 to connect the metal contacts 302 (e.g., VCC pin and GND pin) to the SIM card module 300. The SIM card module 300 can also be connected to the micro-battery in the battery slot 301.

During operation of the SIM card inserted in, for example, a mobile phone, when the mobile phone is switched on and is able to provide sufficient working current to the SIM card, the SIM card uses the power supplied by the mobile phone and the micro-battery is charged. When the mobile phone is switched on but unable to provide sufficient power to the SIM card, the SIM card uses the power supplied by both the mobile phone and the micro-battery, and the micro-battery may provide the additional power exceeding the power supplied by the mobile phone. Further, when the mobile phone is turned off or in a standby mode, the SIM card uses power supplied by the micro-battery.

In certain other embodiments, the SIM card may be replaced with other type of IC card, such as an UIM card, a USIM card, an RF UIM card, or an RF USIM card. The built-in micro-battery can provide sufficient power even when these smart cards include extended functionalities and are operated in various operating environment and/or applications. The IC card may also be adapted to various different configurations and/or structures.

FIG. 9 shows an exemplary IC card system consistent with the disclosed embodiments. As shown in FIG. 9, IC card 40 includes an ISO7816 interface 400, a power management module 500, a microprocessor and memory module 600, and an RF module 700. Other components may also be included.

With the RF module 700, the IC card 40 may be referred as an RF IC card and may include an RF SIM card, an RF UIM card, or an RF USIM card, etc. The RF module 700 may be used to implement RF communication functions, such as the RF communication for electronic payment and access control, etc. Of course, the RF module 700 as well as other components may be omitted.

The ISO7816 interface 400 may include any appropriate interface device that is compatible with certain standard, such as ISO7816 or other interface standards. The ISO7816 interface 400 may provide various signal lines for normal operation of the IC card 40, such as power input line, ground line, and other signal lines.

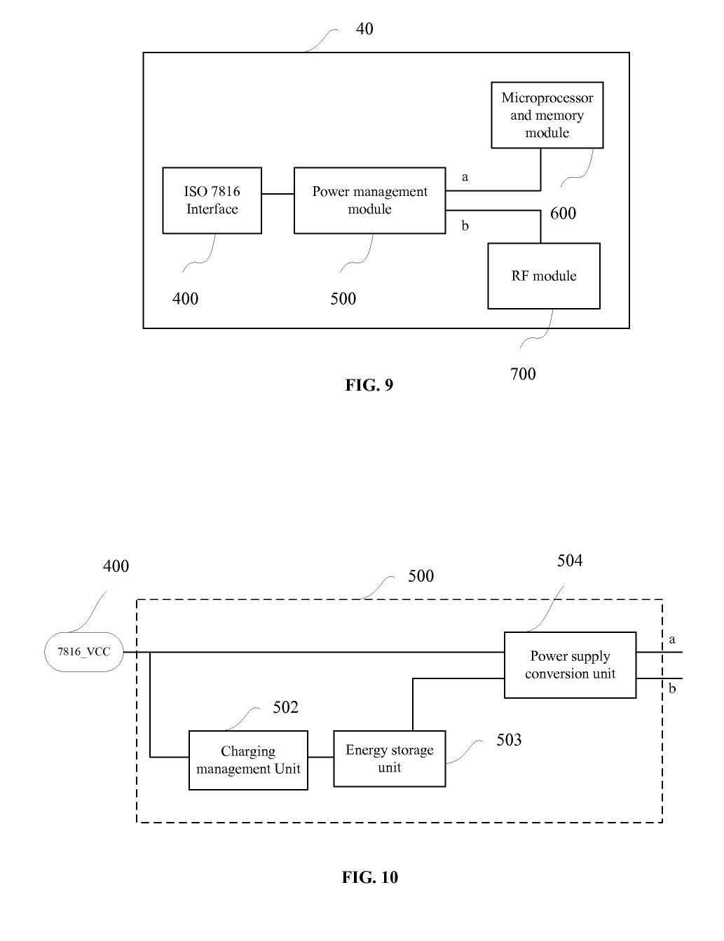

The power management module 500 is used to provide electric charge for the IC card 40 under a normal working condition as well as under an extraordinary working condition. With the power management module 500, power can be supplied to the IC card 40 even if the power needed by the IC card 40 goes beyond the power provided under the normal work condition. FIG. 10 shows an exemplary power management module 500.

As shown in FIG. 10, the power management module 500 may include a charging management unit 502, an energy storage unit 503, and a power supply conversion unit 504. Other components may also be included.

The charging management unit 502 is used to convert input current into electric charge stored in the energy storage unit 503. The energy storage unit 503 is used to store the electric charge, and the power supply conversion unit 504 is used to select between the power input line 7816_VCC from the ISO7816 interface 400 and the energy storage unit 503, or select both, to supply power to the IC card 40.

More specifically, the input of the charging management unit 502 is coupled to the power input line 7816_VCC of the ISO7816 interface 400, and the output of the charging management unit 502 is coupled to the input of the energy storage unit 503. One input of the power supply conversion unit 504 is coupled to the power input line 7816_VCC of the ISO7816 interface 400, and another input of the power supply conversion unit 504 is coupled to the output of the energy storage unit 503. Further, the output of the power supply conversion unit 504 is coupled to power supply input line of the IC card 40. The power supply input line of the IC card may be referred as the power supply input line for other components on the IC card 40 except the power management module 500. The power supply input line may include one or more input lines (e.g., in FIG. 9, power supply input lines ‘a’ and ‘b’ are shown, line ‘a’ may be the power supply input line SIM_VCCD for the microprocessor and memory module 600, and line ‘b’ may be the power supply input line SIM_VCCRF for the RF module 700.

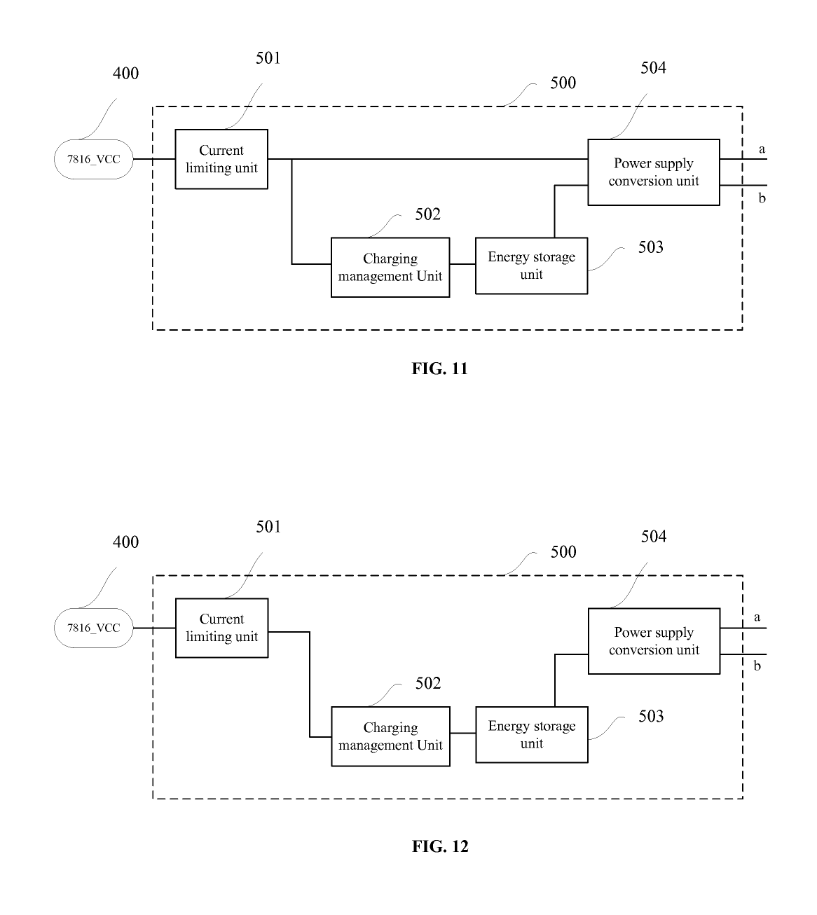

This structure may be suitable for IC card 40 with relative small pulse current. Otherwise, a current limiting unit may be included to limit the pulse current. FIG. 11 and FIG. 12 illustrate another exemplary IC card 40 incorporating a current limiting unit 501 consistent with the disclosed embodiments. Because the current limiting unit 501 in FIG. 11 and FIG. 12 is similar to the current limiting unit 112 in FIG. 3 and FIG. 4, detailed descriptions are omitted.

Thus, the power management device 500 provides functionalities of pulse current limiting, electric charge storage, and multiple-input power supply, etc. In operation, using a mobile-phone-based IC card as an example, when the mobile phone turns on the power supply circuitry of the IC card, the power management unit 500 charges its internal energy storage unit 503 using input current not exceeding a maximum limit, until the energy storage unit 503 is saturated. When the mobile phone turns off the power supply circuitry of the IC card, the power management unit 500 preserves the stored electric charge and minimize the loss of the stored electric charge except the power consumption by the IC card itself. Further, when the IC card is operational and needs power, the power management device 500 can obtain power supply either from its internal energy storage unit 503 or from the power input line.

Further, the charging management unit 502 may be similar to the charging management 122 described in previous sections. However, the charging management unit 502 may be adapted to work with ISO7816 interface 400. For example, the charging management 122 may be a DC-DC circuit or an electric-charge-pump charging circuit to boost the 3.3V from the ISO7816 interface to 5V. The charging management unit 502 may include a boost converter to store the inputted electric charge at a higher voltage, such that the electric charge storage capacity can be increased.

The energy storage unit 503 may be similar to the energy storage unit 132 described in previous sections. Further, for an RF SIM card application, the charging capacitor C may be determined based on the following algorithms.

(1) Setting the input and output conditions of the power management unit 500:

Input Settings:
7816_VCC input current and voltage I₇₈₁₆*V₇₈₁₆ (10 mA@3.3V);
power supply conversion unit 504 DC/DC conversion efficiency η (90%);
charging management conversion efficiency y (90%) and the output Vc (5V);
RF SIM card guaranteed successful card read period (minimum 20 ms).

### Output Settings:

microprocessor and memory module 600 power requirement: SIM_VCCD: I_{D}@V_{D} (5 mA@3.3V);
RF module power requirement: SIM_VCCRF: I_{RF}@V_{RF} (15 mA@2V);
the capacitor C discharges from Vc (5V) to ½ of Vc (2.5V) to ensure the normal operation of the power supply conversion unit 204.

(2) Based on the input power, the output power, and the conversion efficiencies, using the Law of conservation of power to calculate the capacitance as follows:

the input power of the power supply conversion unit 204 is:

DC/DC input power: P₇₈₁₆=I₇₈₁₆*V₇₈₁₆;

capacitor input power: C*(ΔV)²/t.

the output power of the power supply conversion unit 204 is:

SIMVCCRF port: P_{RF}=I_{RF}*V_{RF};

SIMVCCD port: P_{D}=I_{D}*V_{D}.

According to the law of conservation of power:

Input power*η=output power, i.e.,

(P₇₈₁₆+C*(ΔV)²/t)*η=P_{RF}+P_{D} (1)

Thus, the capacitance C can be derived as:

$$C = \frac{( {P}_{RF} + {P}_{D} - {P}_{7816} * η ) * t}{η * {( Δ V )}^{2}} \qquad ( 2 )$$

Substituting the values of these variables, C=60 uF

When the charging management unit 502 charges the capacitor C, based on the charging circuit time constant τ1=R1*C, if the resistor R1 is selected at around K level, the charging time is at ms level. On the other hand, the energy storage unit 503 discharges 2.5V within 20 ms with a time constant τ2=R2*C. Thus, the resistor R2 may have a resistance value of approximately 1K. Other values may also be used.

In practice, the capacitance C, for example at 60 uF, may be in the form of one or more capacitors integrated in the RF SIM card, and resistors at K level may also be easily integrated in the RF SIM card.

The energy storage unit 503 may be a capacitor or a miniature rechargeable battery such that the energy storage unit 503 can be embedded into the IC card 40. The capacitance of the energy storage unit 503 may be determined based on the actual applications. For example, when the actual consumption of electric charge for one transaction is used to determine the capacitance, often a capacitor of 100 uF with a breakdown voltage of 5V may be sufficient to store enough electric charge to complete one transaction. When using capacitor to store electric charge, the energy storage unit 503 may increase the capacitance and/or the storage voltage to increase the electric charge storage capacity.

In certain embodiments, the energy storage unit 503 may also include a voltage detection circuit to measure the input voltage of the charging management unit 502 and the voltage of the energy storage unit 503. When the input voltage exceeds a preset threshold and the voltage of the energy storage unit 203 is less than a preset level, the charging management unit 502 may start the charging function to charge the energy storage unit 503 and to stop the charging function when the energy storage unit 503 is fully charged. Further, when the voltage on the microprocessor and other components is not sufficient and the energy storage unit 503 is full, the energy storage unit 503 discharges power to the power supply conversion unit 504.

Further, the power supply conversion unit 504 may be a DC-DC converter. The power supply conversion unit 504 may also include a power detection circuit. When detecting that the IC card microprocessor and other components do not have sufficient voltage, the power supply conversion unit 504 may start power supply conversion functions to draw electric charge from the energy storage unit 503 and to provide the power to the IC card. The power supply conversion unit 504 can also include a multi-channel power supply combination device, which may separately detect the voltage of each input channel. When a specific input channel has a voltage exceeding a preset value, the power supply conversion unit 504 may open that specific input channel to supply power to the IC card.

More particularly, the power supply conversion unit 504 may be a dual-input and dual-output DC-DC converter. The two inputs are respectively connected or coupled to the ISO7816 interface 400 and the output of the energy storage unit 503, and the two outputs are respectively connected or coupled to the power input lines of the RF module 700 and the microprocessor and memory module 600. When power required is low or the RF module 700 is not operational, the power supply conversion unit 504 may only turn on the ISO7816 interface but turn off the discharging output of the energy storage unit 503. On the other hand, when power required is high or the RF module 700 is operational, the power supply conversion unit 504 may turn on both the ISO7816 interface and the output of the energy storage unit 503.

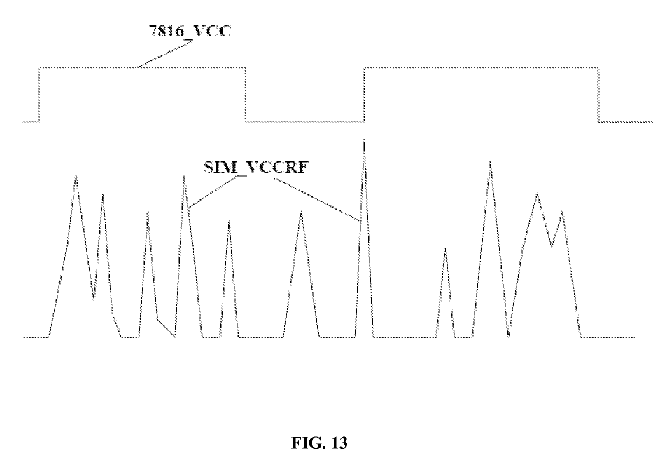

FIG. 13 shows exemplary input current and output current diagrams of the IC card consistent with the disclosed embodiments. As shown in FIG. 13, because the power management module 500 may be able to keep the input current in a limited range (e.g., 10 mA) and relative stable, as shown by 7816_VCC. The output current is provided to the RF module 700 and other circuitry and is in general intermittent and random, as shown by SIM_VCCRF. The maximum output current is greater than the input current (e.g., 15 mA).

By using the disclosed structures and methods, IC card systems can solve issues of limited current supply for the IC cards by using a power management device. Such IC cards have electric charge storage functionality and can include components in an ordinary IC card, such as microprocessor, memory, and ISO7816 interface, as well as RF modules to support extended RF communication or other functional modules.

The disclosed ID card systems may provide various advantages. For example, the disclosed ID card system uses a current limiting circuit device to reduce power-on pulse current such that the power-on current can be controlled with the preset maximum range of the external power source, thus less likely to cause the external power source being disconnected due to overdrawn protection.

Further, the disclosed ID card system can store electric charge from the input current using an energy storage circuit device, and provide power using the stored electric charge for a certain period of time. In addition, the disclosed ID card system can simultaneously draw power from the internal energy storage unit and from external power input line to supply the chips and other components in the IC card system for a certain period of time, which solves the existing problem of requiring a large current under extraordinary working conditions.

In addition, when incorporated into a mobile phone and the mobile phone is unable to supply sufficient power, the disclosed IC card system can convert limited power supply by the mobile phone into voltage and current output satisfying the IC card's requirements for normal operation. Thus, even when the mobile phone is turned off or does not have sufficient battery, the IC card can complete transactions by using capacitor(s) having appropriate capacity or a micro-battery.

Therefore, even with extended RF functionalities and higher power consumption, the disclosed IC card system can still be compatible with the existing mobile phones, because the requirement for power supply may be kept the same as that of an ordinary mobile phone without incorporated RF IC card. Other advantages, applications, and modifications may be obvious to those skilled in the art.

What is claimed is:

1. A integrated circuit (IC) card, comprising:
a microprocessor and memory module configured to perform a transaction associated with the IC card;
an interface device providing a power input line from an external source;
a power management module coupled between the microprocessor and memory module and the interface device to convert power from the power input line into electric charge, to store the electric charge internally, and to provide power to the microprocessor and memory module when the external source does not provide sufficient power to the IC card.

2. The IC card according to claim 1, wherein:
the interface device is an ISO7816 interface device.

3. The IC card according to claim 1, wherein:
an RF module coupled to the power management module for power supply.

4. The IC card according to claim 2, wherein the power management module further includes:
a charging management unit configured to convert the power into the electric charge to be stored in the energy storage unit;
an energy storage unit configured to store the electric charge; and
a power supply conversion unit configured to select at least one of the external source and the output of the energy storage unit to provide power to the IC card,
wherein:
an input of the charging management unit is coupled to a power input line 7816_VCC from the interface device;
an output of the charging management unit is coupled to an input of the energy storage unit;
one input of the power supply conversion unit is coupled to the power input line 7816_VCC; and
another input of the power supply conversion unit is coupled to the output of the energy storage unit.

5. The IC card according to claim 2, wherein the power management module further includes:
a current limiting unit configured to limit any input pulse current exceeding a preset threshold;
a charging management unit configured to convert the power into the electric charge to be stored in the energy storage unit;
an energy storage unit configured to store the electric charge; and
a power supply conversion unit configured to select at least one of the external source and the output of the energy storage unit to provide power to the IC card,
wherein:
an input of the current limiting unit is coupled to a power input line 7816_VCC from the interface device;
an input of the charging management unit is coupled to an output of the current limiting unit;
an output of the charging management unit is coupled to an input of the energy storage unit;
one input of the power supply conversion unit is coupled to the output of the current limiting unit; and
another input of the power supply conversion unit is coupled to the output of the energy storage unit.

6. The IC card according to claim 1, wherein the power management module further includes:
a current limiting unit, a charging management unit, an energy storage unit, and a power supply conversion unit coupled in series,
wherein:
the current limiting unit is configured to limit any input pulse current exceeding a preset threshold;
the charging management unit is configured to convert the power into the electric charge to be stored in the energy storage unit;
the energy storage unit is configured to store the electric charge; and
the power supply conversion unit is configured to select at least one of the external source and the output of the energy storage unit to provide power to the IC card.

7. The IC card according to claim 1, wherein the current limiting unit further includes:
a filter capacitor coupled to the power input line;
a switch coupled between the filter capacitor and ground; and
a power-on reset circuit coupled to the switch to add a delay period before closing the switch when power-on.

8. The IC card according to claim 1, wherein the energy storage unit further includes:
a charging switch, a charging current limiting resistor, a discharging resistor, and a discharging switch coupled in series; and
a charging capacitor coupled between the ground and a junction of the charging current limiting resistor and discharging resistor.

9. A storage card, comprising:
a storage card module configured to provide storage functions associated with the storage card; and
a charge storage module coupled to the storage card module,
wherein the charge storage module is configured to convert power from a power input line into electric charge, to store the electric charge internally, and to provide power to the storage card module when the external source does not provide sufficient power to the storage card.

10. The storage card according to claim 9, wherein:
an RF module coupled to the charge storage module for power supply.

11. The storage card according to claim 9, wherein the charge storage module further includes:
a charging management unit configured to convert the power into the electric charge to be stored in the energy storage unit;
an energy storage unit configured to store the electric charge; and
a power supply conversion unit configured to select at least one of the power input line and the output of the energy storage unit to provide power to the storage card,
wherein:
an input of the charging management unit is coupled to the power input line;
an output of the charging management unit is coupled to an input of the energy storage unit;
one input of the power supply conversion unit is coupled to the power input line; and
another input of the power supply conversion unit is coupled to the output of the energy storage unit.

12. The storage card according to claim 9, wherein the charge storage module further includes:
a current limiting unit configured to limit any input pulse current exceeding a preset threshold;
a charging management unit configured to convert the power into the electric charge to be stored in the energy storage unit;
an energy storage unit configured to store the electric charge; and
a power supply conversion unit configured to select at least one of the external source and the output of the energy storage unit to provide power to the storage card,
wherein:
an input of the current limiting unit is coupled to the power input line;
an input of the charging management unit is coupled to an output of the current limiting unit;
an output of the charging management unit is coupled to an input of the energy storage unit;
one input of the power supply conversion unit is coupled to the output of the current limiting unit; and
another input of the power supply conversion unit is coupled to the output of the energy storage unit.

13. The storage card according to claim 9, wherein the charge storage module further includes:
a current limiting unit, a charging management unit, an energy storage unit, and a power supply conversion unit coupled in series,
wherein:
the current limiting unit is configured to limit any input pulse current exceeding a preset threshold;
the charging management unit is configured to convert the power into the electric charge to be stored in the energy storage unit;
the energy storage unit is configured to store the electric charge; and
the power supply conversion unit is configured to select at least one of the external source and the output of the energy storage unit to provide power to the storage card.

14. The storage card according to claim 9, wherein the current limiting unit further includes:
a filter capacitor coupled to the power input line;
a switch coupled between the filter capacitor and ground; and
a power-on reset circuit coupled to the switch to add a delay period before closing the switch when power-on.

15. The storage card according to claim 9, wherein the energy storage unit further includes:
a charging switch, a charging current limiting resistor, a discharging resistor, and a discharging switch coupled in series; and
a charging capacitor coupled between the ground and a junction of the charging current limiting resistor and discharging resistor.

16. The storage card according to claim 11, wherein:
the charging management unit is a DC-DC converter

17. The storage card according to claim 11, wherein:
the power supply conversion unit is a DC-DC converter.

18. The storage card according to claim 11, wherein:
the energy storage unit is a micro-battery.

19. The storage card according to claim 9, wherein:
the storage card module include one of an SD card module, a TF card module, an MMC card module, an RF SD card module, and an RF TF card module.
